(19) United States
(12) Patent Application Publication
(10) Pub. No.: US 2023/0052969 A1
(43) Pub. Date: Feb. 16, 2023

(54) PUMPING SYSTEM FOR ABSORPTION HEAT PUMP CIRCUITS

(71) Applicant: ARISTON S.P.A., Fabriano (IT)

(72) Inventors: Pietro Brevi, Bagnatica (IT); Gianmarco Cabri, Collecchio (IT); Piero Agostino Galli, Baranzate (IT); Giorgio Vitaioli, Camerano (IT)

(21) Appl. No.: 17/817,916

(22) Filed: Aug. 5, 2022

(30) Foreign Application Priority Data
Aug. 9, 2021 (IT) 102021000021521

(51) Int. Cl. F25B 49/04; F25B 15/00

(52) U.S. Cl. CPC F25B 49/043; F25B 15/008

(57) ABSTRACT

The invention relates to a system for pumping a refrigeration mixture for absorption heat pump generators, comprising a support which integrates a membrane pump and a hydraulic pump for actuating the membrane pump in a single component, and using the driving feedback signals of the actuator motor, determines the existing fluid-dynamic conditions during the operation of the heat pump.

### CROSS-REFERENCE TO RELATED APPLICATIONS

This application claims priority to Italian Patent Application No. 102021000021521 filed on Aug. 9, 2021, the entire disclosure of which is expressly incorporated herein by reference.

### STATEMENT RE: FEDERALLY SPONSORED RESEARCH/DEVELOPMENT

Not Applicable

### BACKGROUND

### Field of the Invention

The present invention relates to the technical field of absorption heat pumps. In further detail, the present invention relates to the technical field of pumps used for transferring mixtures containing refrigerants, in general water-ammonia or lithium bromide-water, between absorber and generator in absorption heat pump plants.

### Background Art

Absorption heat pumps are based on a reciprocating cycle in which the refrigerant, in general ammonia (NH₃) or water in lithium bromide (LiBr) systems, passes from the high pressure environment (condenser) to the low pressure environment (evaporator) through an expansion or throttling stage to then return, after an absorption process, to the high pressure stage by means of a pump, rather than by means of a compressor, as in the vapor compression refrigeration cycles. In this type of plants, indeed, the output vapor from the evaporator is absorbed in a liquid solution, pumped, brought to the vapor phase, and then separated from the solution before starting a new cycle.

Condenser and evaporator are traditional components consisting of pipes placed in contact with the service fluids (they can be water or air in the ammonia absorption heat pump) in which the refrigerant flows, yielding heat to the condenser (on the high temperature side) and removing it from the evaporator (on the low temperature side).

The absorption occurs in an absorber and is promoted by the heat removal. The lower the temperature reached, the smaller the amount of solution required to absorb the cooling vapor.

The separation of the liquid solution occurs in a generator by introducing heat. Since the released vapors do not exclusively consist of refrigerant vapors, a rectifier is generally present between the generator and the condenser to ensure a certain purity of the refrigerant.

The transformations the refrigerant is subjected to form the cycle of the absorption heat pump. The energy required for operation is supplied by the generator, in particular by a burner, conventionally a gas burner, which heats the refrigerant-enriched solution by means of a flame tube. A small amount of electricity is then required to drive the pump.

The presence of refrigerants such as ammonia requires the heat pump circuit to be made of steel since the materials containing metals such as aluminum, copper or zinc cannot be used due to the corrosion to which they would be subjected. Therefore, since the circuit containing the refrigerant is to be sealed from the environment, the construction thereof requires weldings made with different technology and various and more costly apparatuses than the more common brazing joints used in vapor compression machines utilizing fluorinated gases.

As for the pump, there is a need in these absorption systems to pump an ammonia/water or water/lithium bromide solution from a low pressure of about 0-4 bar at the outlet from the absorber to a high pressure in the order of 20-25 bar at the inlet to the generator. The system flow rate depends on the power of the heat pump, which conventionally is in the order of 5 liters/hour per kW of thermal power.

Therefore, the pumps used in these systems must be capable of operating with toxic fluids with high pressure gradient and relatively low flow rate. Moreover, they must be capable of operating in the complete absence of lubricant (even small traces of oil prevent the absorption phenomenon) and for a time period which is to be at least equal to that of the expected duration of the product as a whole due to the inability/impossibility to carry out maintenance.

This imposes particular construction architectures/layouts mostly referred to configurations adopting membrane pumps driven by hydraulic pumps.

A membrane pump consists of two chambers separated by a membrane. By creating a pressure/vacuum in one of the two chambers, the membrane is deformed, thus causing a corresponding pressure/vacuum in the other chamber. By connecting an intake duct and a delivery duct to one of the two chambers by means of automatic valves which open in opposite direction when a given pressure is reached, a liquid may be drawn from the low pressure intake duct to send it into the high pressure delivery duct, thus utilizing the vacuum and the subsequent pressure caused by the motion of the membrane induced by depressurizing/pressurizing the oil in the other chamber.

Thereby, the mixture containing the refrigerant is kept separate from the environment and does not risk of being contaminated by lubricants required to operate the traditional pumps provided with moving mechanical members.

However, this solution has some drawbacks. The “membrane pump” and the “hydraulic pump” are two distinct components connected by high pressure ducts to alternatively transfer pressurized oil between the two pumps. This causes complexities and high costs. Moreover, at present the hydraulic pump is driven by an AC motor including a belt gear motor for moving the membrane at a speed such as not to cause cavitation in the solution containing the refrigerant and prevent stresses associated with the stepped opening of the delivery valves. The gear motor belt is a critical component subject to wear which requires to be replaced about every 10,000 operating hours. Other types of gear motors (e.g., helical gear motor) are not capable of withstanding the strong pulse loads provided by the application and for the duration required for an HVAC application.

It is the object of the present invention to provide a compact pumping system capable of transferring mixtures containing refrigerants from the absorber to the generator of an absorption heat pump in a safe, reliable manner and with a small number of components.

### BRIEF SUMMARY

The present invention achieves the object with a system for pumping a refrigeration mixture for absorption heat pump generators, comprising a support, in which support a first housing for a cylinder in which a piston slides and a second housing for a membrane are obtained, where the second housing is closed by a plate, the membrane dividing the second housing into a non-communicating first chamber and second chamber. The first chamber communicates with the head of the cylinder by means of the support so that the reciprocating motion of the piston causes a pressure/vacuum of a fluid present in the first chamber so that the membrane can be deformed, thus causing a corresponding pressure/vacuum in the second chamber, the second chamber communicating with an intake duct and a delivery duct of the refrigeration mixture, there being provided automatic valves for closing the delivery duct when a vacuum adapted to draw the refrigeration mixture is created inside the chamber, and for closing the intake duct when an overpressure adapted to send the refrigeration mixture into the pressurized delivery duct is created inside the chamber.

This allows obtaining a decrease in the number of components, overall dimensions, weight, and cost of the pumping system.

In an embodiment, there are two membranes arranged in corresponding housings operating in parallel under the action of a pair of pistons driven by a single motor or by two separate motors.

In an advantageous configuration, the piston(s) are driven by an electric motor with direct drive type technology. This allows eliminating the use of the gear motor, in particular of the belt which is a critical component thereof.

Moreover, the direct drive technology allows having a feedback on the drive by monitoring the course of the current absorbed over time. This is particularly advantageous because it allows obtaining useful information to define operating parameters within the pumping system (e.g., pressures and flow rates).

According to an aspect, the invention also relates to an absorption heat pump plant comprising a generator, a condenser, a first expansion valve, an evaporator, an absorber, a pumping system according to the invention, and a second expansion valve, connected so as to subject a refrigerant to thermodynamic absorption cycles.

The plant can advantageously comprise a control unit for setting the operating parameters of the plant itself, where said control unit is interfaced with the pumping system to detect the fluid-dynamic parameters of the pumping system and correspondingly act on the plant components.

The further features and improvements are the subject of the sub-claims.

### BRIEF DESCRIPTION OF THE DRAWINGS

Further features and advantages of the invention will become apparent from the reading of the following detailed description, given by way of a non-limiting example, with the aid of the figures shown on the accompanying drawings, in which:

FIG. 1 schematically shows the components of an absorption heat pump.

FIG. 2 schematically shows the pressures and temperatures in an absorption cycle.

FIG. 3 schematically shows the operating principle of a membrane pump.

FIG. 4 shows a pumping system according to an embodiment of the invention.

The following description of exemplary embodiments relates to the accompanying drawings. The same reference numbers in the various drawings identify the same elements or similar elements. The following detailed description does not limit the invention. The scope of the invention is defined by the appended claims.

### DETAILED DESCRIPTION

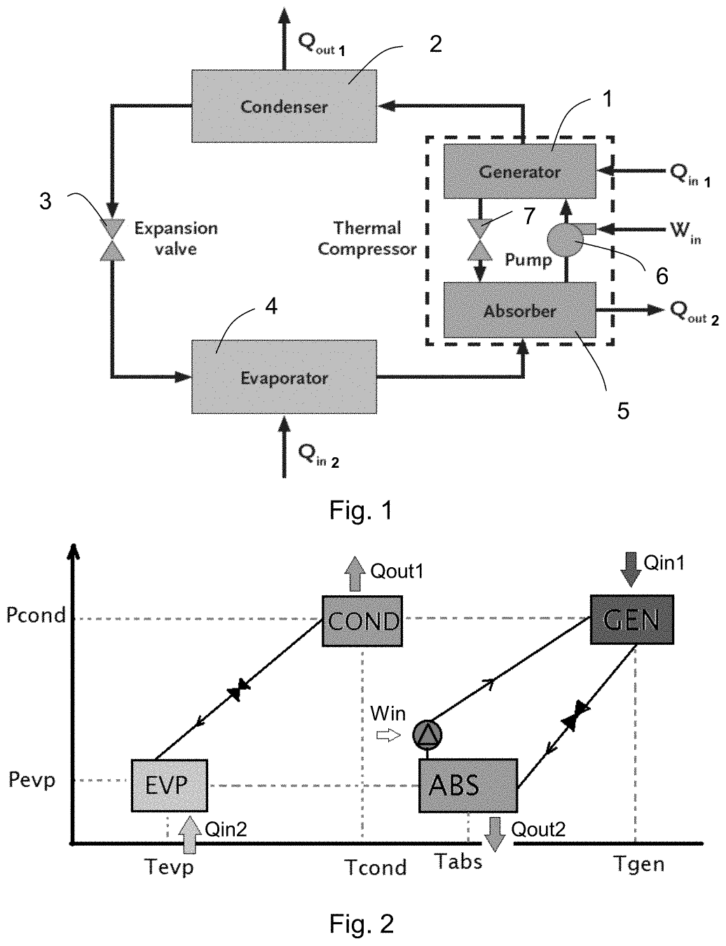

With reference to FIG. 1, an absorption heat pump comprises a generator 1, a condenser 2, a first expansion valve 3, an evaporator 4, an absorber 5, a pumping system 6, and a second expansion valve 7.

The fluid evolving in the machine is a mixture containing a cooling substance, for example ammonia in water. Due to an amount of heat Qin1 which is supplied to generator 1, for example by means of a gas burner, the refrigerant, being the most volatile component of the mixture, separates from the solution. The vapor thus generated is sent to condenser 2, where it condenses by yielding heat Qout1 to an external source. Generator 1 and condenser 2 are both at a pressure Pcond which depends on the condensation temperature Tcond.

The refrigerant is then brought to a lower pressure Pevap by means of an expansion valve 3 and then sent to evaporator 4 in which it evaporates, removing heat Qin2 from an external source.

For the cycle to be repeated, the refrigerant needs to be brought back to solution. Such a task is assigned to absorber 5 in which the vapor of the low temperature refrigerant Tevp from evaporator 4 and the solution from generator 1 brought back to low pressure by an expansion valve 7 meet. Heat Qout2 also needs to be removed from absorber 5 to allow the condensation of the refrigerant and the dilution of the solution. The solution thus enriched is brought to high pressure Pcond by the pumping system 6 to be introduced into generator 1 again, where it starts its cycle again. The pumping system 6 absorbs electricity (indicated by Win in the drawing).

FIG. 2 schematically shows the pressures and temperatures involved in an absorption cycle like that described above indicating the energy exchanged by means of arrows.

Overall, the energy balance is as follows:

Qₒᵤₜ₁+Qₒᵤₜ₂=Qᵢₙ₁+Qᵢₙ₂+Wᵢₙ→Q_{COND}+Q_{ASSORB}=Q_{GEN}+Q_{EVAP}+W_{POMPA}

While the heating and cooling efficiencies are given by:

$${η}_{COOL} = \frac{{Q}_{in 2}}{{Q}_{in 1} + {W}_{in}} = \frac{{Q}_{EVAP}}{{Q}_{GEN} + {W}_{POMPA}}$$

$${η}_{HEAT} = \frac{{Q}_{out 1} + {Q}_{out 2}}{{Q}_{in 1} + {W}_{in}} = \frac{{Q}_{COND} + {Q}_{ASSORB}}{{Q}_{GEN} + {Q}_{POMPA}} = \frac{{Q}_{GEN} + {Q}_{EVAP} + {W}_{POMPA}}{{Q}_{GEN} + {W}_{POMPA}} = 1 + \frac{{Q}_{EVAP}}{{Q}_{GEN} + {W}_{POMPA}}$$

Several variants are possible starting from the base diagram shown in FIG. 1, mostly aiming to optimize the thermal exchanges and therefore increase the efficiencies, for example by using recuperative exchangers.

As for the pumping system 6, this conventionally comprises a membrane pump actuated by a hydraulic pump by means of a pressurized duct.

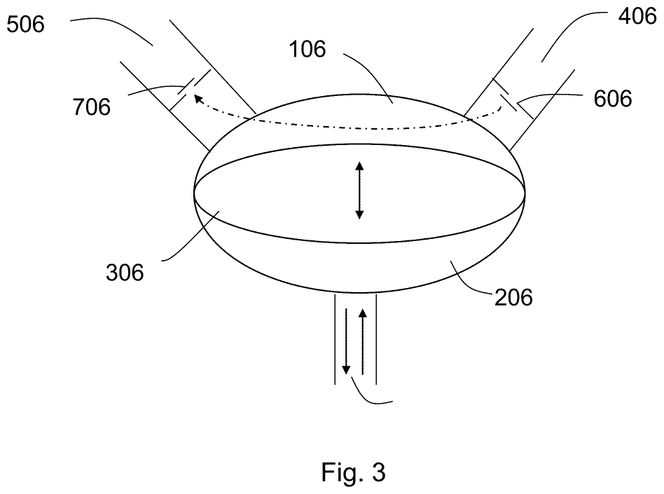

With reference to the exemplary diagram shown in FIG. 3, a membrane pump 60 consists of two chambers 106, 206 separated by a membrane 306. By creating a pressure/vacuum in one of the two chambers 106, 206, the membrane 306 is deformed, thus causing a corresponding pressure/vacuum in the other chamber 206, 106. By connecting an intake duct 406 and a delivery duct 506 to one of the two chambers 106 by means of automatic valves 606, 706, which open in opposite direction when a given pressure is reached, a liquid can be drawn from the low pressure intake duct 406 to send it into the high pressure delivery duct 506, thus utilizing the vacuum and the subsequent pressure caused by the motion of the membrane, as shown by the arrows in the drawing. Oil is used to move the membrane, which oil is alternatively introduced/drawn into/from the other chamber 206 by a hydraulic piston pump (not shown). The actuation of the hydraulic pump occurs by means of an electric bel-reduction motor.

The invention relates to an improvement of the known pumping systems.

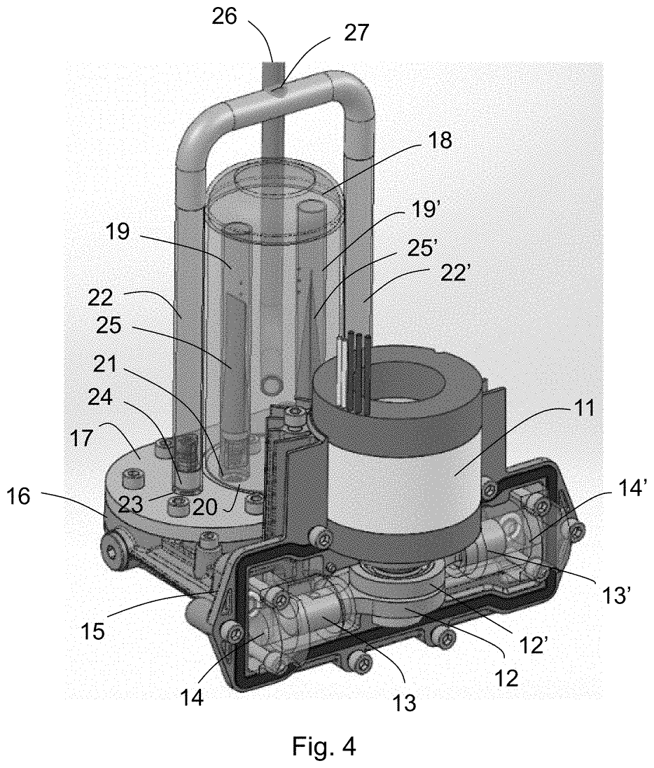

FIG. 4 shows a pumping system 6 according to an embodiment of the present invention. The system comprises an electric motor 11 connected by a linkage 12, 12′ to a pair of pistons 13, 13′ which move coaxially in opposite directions inside corresponding cylinders 14, 14′. The cylinders are enclosed in a box-shaped body 15 extending transversely to the cylinders to form a support base for the whole pumping system, the cylinders 14, 14′ forming the front part thereof. Two separate housings 16, 16′ communicating with the corresponding cylinders 14, 14′ by means of the box-shaped body 15 are obtained in the rear part of the box-shaped body 15. Thereby, the oil pushed or drawn by the head of each of the two cylinders 14, 14′ is capable of reaching the corresponding housing 16, 16′ without requiring the use of pressurized ducts. The section of the box-shaped body 15 can be advantageously reduced to reduce the amount of oil required to keep the fluid-dynamic connection between head of the cylinders 14, 14′ and corresponding housings 16, 16′.

Each housing 16, 16′, typically cylindrical in shape, is closed at the top by a flange 17, 17′ by the interposition of a membrane (not shown in the drawing) so as to form a pair of chambers separated by the membrane itself. There can be only one closing flange which advantageously closes both housings.

The first chamber, adapted to receive the pressurized oil from the corresponding cylinder, is located at the bottom between box-shaped body and membrane, while the second chamber, adapted to draw and send under pressure the mixture containing the refrigerant, is located at the top of the first one, between membrane and closing flange.

The container 18 of the solution to be pumped is located in median position above the two flanges 17, 17′ so as to allow the intake of the contents thereof by means of an intake duct 19, 19′ arranged at an opening 20, 20′ made on each closing flange 17, 17′ to form an intake gap. There is a valve 21, 21′ between duct and intake gap for automatically closing the fluid-dynamic intake circuit when the solution chamber is pressurized.

The delivery duct 22, 22′ of the output pressurized solution is placed at another opening 23, 23′ made on the closing flange 17, 17′. Also in this case, there is a valve 24, 24′ between delivery duct 22, 22′ and delivery gap 23, 23′ for automatically closing the fluid-dynamic delivery circuit when the solution chamber is depressurized.

The two valves 21, 21′ and 24, 24′ operate in an opposite manner, i.e., when one opens, the other one closes, to ensure the pumping effect as described above with reference to FIG. 3.

The circuit is completed with a pair of filters 25, 25′ located in the intake ducts 19, 19′ and a supplying duct 26 for the solution tank 18. The delivery ducts 22, 22′ can be kept separate or be joined, as shown in the drawing. In this case, a T sleeve 27 collects the pressurized fluid output from each chamber.

The solution shown with dual cylinder and dual membrane is considered preferable because it allows reaching the pressure gradients required more easily with the low flow rates involved, thus simultaneously ensuring an absence of cavitation. It is obviously possible to provide the use of a pumping system comprising a single cylinder and a single membrane, as well as intermediate combinations, for example having a single cylinder in communication with two chambers each housing one membrane, or two cylinders controlled by two separate motors.

The motor(s) 11 advantageously are of the direct drive type, i.e., with load directly connected to the rotor. These motors are capable of delivering variable torques, even at a low number of revolutions, without requiring the use of gear trains or gear motors of any type by virtue of their characterizing electronic control.

A direct drive motor is a type of synchronous permanent magnet motor which directly actuates the load. When this type of motor is used, the use of a reducer is eliminated. Therefore, the number of movable components in the system is significantly reduced. This increases the efficiency and creates a silent and highly dynamic operation, as well as a very high duration of the system.

Examples of direct drive motors are torque motors, linear motors, and certain types of BLDC motors.

Direct drive motors are highly suitable for applications with significant torque fluctuations. This is because they just need a low torque to accelerate the motor with respect to gear motors, which have a lower torque/inertia ratio.

Moreover, they can also be provided as frameless motors. Frameless relates to a motor without a frame, housing, bearings, or feedback system. Accordingly, the plant suppliers are capable of integrating their motor in the application itself, eliminating the need for a further interfacing. This obviously decreases the cost of the integrated system.

A direct drive motor can be used in an absorption heat pump application due to the high torque at low angular speed, small dimensions, small weight, maximum power, presence of driving electronics providing an optimal speed control and useful information on rotor position and absorbed currents.

The direct drive motor can provide complete control of the electric absorption parameters precisely due to the presence of the electronic control. By connecting such an interface to a control unit, it is possible to read and process said parameters in order to determine the flow conditions of the operating pumping system.

Thereby, the same control unit or a plant control interfaced with the control unit or directly with the motor(s) of the pumping system can advantageously set the operating parameters of the plant based on the flow conditions of the pumping system.

What is claimed is:

1. An absorption heat pump plant comprising a generator, a condenser, a first expansion valve, an evaporator, an absorber, a pumping system and a second expansion valve, connected so as to subject a refrigerant mixture to thermodynamic absorption cycles wherein the pumping system comprises a support, in which support a first housing is obtained for a first cylinder in which a first piston, connected to a direct drive motor, slides, and a second housing for a first membrane, wherein the second housing is closed by a plate, the first membrane dividing the second housing into a non-communicating first chamber and second chamber, the first chamber communicating with the head of the first cylinder by means of the support so that the reciprocating motion of the piston causes a pressure/vacuum of a fluid present in the first chamber so that the first membrane may be deformed, thus causing a corresponding pressure/vacuum in the second chamber, the second chamber communicating with a first intake duct and a first delivery duct of the refrigeration mixture, there being provided automatic valves for closing the first delivery duct when a vacuum adapted to draw the refrigeration mixture is created inside the second chamber, and for closing the first intake duct when an overpressure adapted to send the refrigeration mixture into the first pressurized delivery duct is created inside the second chamber.

2. The plant according to claim 1, wherein a third housing for a second membrane is obtained in the support, wherein the third housing is closed by a separate plate or by the same plate which closes the second housing, the second membrane dividing the third housing into a non-communicating third chamber and fourth chamber, the third chamber also communicating with the head of the first cylinder by means of the support so that the reciprocating motion of the first piston which slides in the first cylinder causes a pressure/vacuum of the fluid present in the third chamber so that the second membrane may be deformed, thus causing a corresponding pressure/vacuum in the fourth chamber, the fourth chamber communicating with a second intake duct and a second delivery duct of the refrigeration mixture, there being provided automatic valves for closing the second delivery duct when a vacuum adapted to draw the refrigeration mixture is created inside the fourth chamber, and for closing the second intake duct when an overpressure adapted to send the refrigeration mixture into the second pressurized delivery duct is created inside the fourth chamber.

3. The plant according to claim 2, wherein a fourth housing for a second cylinder inside which a second piston, connected to a direct drive motor, slides, is obtained in the support, the head of the second cylinder communicating with the third chamber, which third chamber does not communicate with the first chamber so that it is the reciprocating motion of the second piston to cause a pressure/vacuum of a fluid present in the third chamber, so that the second membrane may be deformed, thus causing a corresponding pressure/vacuum in the fourth chamber.

4. The plant according to claim 2, wherein the first and second delivery ducts communicate with a same outlet sleeve.

5. The plant according to claim 1, wherein there is present a container of the solution to be pumped at the plate so as to allow the drawing of the contents thereof by means of the intake ducts arranged at openings obtained in the closing plate to form intake gaps.

6. The plant according to claim 1, wherein the piston or the pistons are connected to an electric motor by means of a linkage.

7. The plant according to claim 1, wherein the electric motor has an interface for controlling the electric absorption parameters, said interface being connected or connectable to a control unit adapted to read and process said parameters in order to determine the flow conditions of the operating pumping system.

8. The plant according to claim 1, comprising a control unit for setting the operating parameters of the plant, wherein said control unit is interfaced with the control unit of the pumping system, or replaces said control unit, to detect the fluid-dynamic parameters of the pumping system and correspondingly act on the plant components.
